(19) United States
(12) Patent Application Publication
(10) Pub. No.: US 2020/0151640 A1
(43) Pub. Date: May 14, 2020

(54) SYSTEMS AND METHODS FOR SERVICE REQUEST ALLOCATION

(71) Applicant: BEIJING DIDI INFINITY TECHNOLOGY AND DEVELOPMENT CO., LTD., Beijing (CN)

(72) Inventors: Xuewen CHEN, Beijing (CN); Xinguang ZHENG, Beijing (CN); Yang WANG, Beijing (CN)

(73) Assignee: BEIJING DIDI INFINITY TECHNOLOGY AND DEVELOPMENT CO., LTD., Beijing (CN)

(21) Appl. No.: 16/747,513

(22) Filed: Jan. 20, 2020

Related U.S. Application Data
(63) Continuation of application No. PCT/CN2018/096371, filed on Jul. 20, 2018.

(30) Foreign Application Priority Data
Jul. 20, 2017 (CN) 201710597338.3

(51) Int. Cl. G06Q 10/06; G06Q 30/02; G06Q 40/00; G06Q 50/30; G06Q 10/08; G06F 17/11

(52) U.S. Cl. CPC G06Q 10/06315; G06Q 30/0206; G06F 17/11; G06Q 50/30; G06Q 10/08345; G06Q 40/12

(57) ABSTRACT

Systems and methods for allocating service requests are provided. The method may include receiving a service request, determining an estimated value of the service request, and determining at least one candidate service provider for the service request. The method may further include, for each of the at least one candidate service provider, obtaining historical order parameters of the candidate service provider, receiving expected order parameters of the candidate service provider, and determining an order allocation weight of the service request based on the estimated value of the service request, the historical order parameters, and the expected order parameters of the service provider. The method may further include determining a target service provider based on at least one order allocation weight of the service request with respect to the at least one candidate service provider.

### CROSS-REFERENCE TO RELATED APPLICATIONS

The present application is a continuation of International Application No. PCT/CN2018/096371 filed on Jul. 20, 2018, which claims priority to Chinese Patent Application No. 201710597338.3, filed on Jul. 20, 2017, the entire contents of each of which are hereby incorporated by reference.

### TECHNICAL FIELD

The present disclosure generally relates to online-to-offline services, and in particular, to systems and methods for allocating service requests from service requesters to service providers.

### BACKGROUND

Online-to-offline (O2O) services (e.g., food delivery services, car-hailing services, etc.) are becoming increasingly popular in daily life. An online-to-offline service is usually initiated by a service requester sending a service request to an online-to-offline service system. The online-to-offline service system may identify multiple candidate service providers and allocate the service request to a service provider. Usually, a service request can only be allocated to a service provider, and a service provider can only accept a service request at a time. For multiple service requests and multiple service providers, the condition of service requests (e.g., the value, the time, the location, the content) may be different, and the condition of the service providers (e.g., the experience of providing services, the level of services provided, the time and location available for providing services) may be different. Also, service providers usually have their preference for certain types of the service requests. For example, some service providers may prefer simple but low-valued service requests while others may prefer difficult but high-valued service requests. Therefore, it is desirable to provide systems and methods for automatically allocating service requests from service providers to service requesters based on multiple factors including but not limited to the condition of service requests, the condition of the service providers (and/or service requesters), the preference of service providers (and/or service requesters), etc.

### SUMMARY

According to an aspect of the present disclosure, a system is provided. The system may include a storage device including a set of instructions for allocating a service request to a service provider and at least one processor in communication with the storage device. When executing the set of instructions, the at least one processor may be configured to cause the system to receive a first service request, determine an estimated value of the first service request, and determine at least one candidate service provider for the first service request. The at least one processor may be further configured to, for each of the at least one candidate service provider, obtain one or more historical order parameters of the candidate service provider, receive one or more expected order parameters of the candidate service provider, and determine an order allocation weight of the first service request with respect to the candidate service provider based on the estimated value of the first service request, the one or more historical order parameters, and the one or more expected order parameters of the service provider. The at least one processor may be further configured to determine a target service provider of the first service request from the at least one candidate service provider based on at least one order allocation weight of the first service request with respect to the at least one candidate service provider.

In some embodiments, the one or more historical order parameters of the candidate service provider may include a historical online time length of the candidate service provider and total values of historical orders of the candidate service provider; and the one or more expected order parameters include an expected income at unit time.

In some embodiments, to determine the order allocation weight of the first service request with respect to the candidate service provider, the at least one processor may be configured to cause the system to determine an expected income of the candidate service provider based on the historical online time length of the candidate service provider and the expected income at unit time and determine the order allocation weight of the first service request with respect the candidate service provider based on the expected income, the total values of historical orders, and the estimated value of the first service request.

In some embodiments, to determine the order allocation weight of the first service request with respect to the candidate service provider, the at least one processor may be further configured to cause the system to determine an income deviation of the candidate service provider based on the historical online time length of the candidate service provider, the expected income at unit time, and the total values of historical orders of the candidate service provider, compare the income deviation of the candidate service provider with at least one income threshold, and determine a grade of the candidate service provider based on a result of the comparison between the income deviation and the at least one income threshold. The at least one processor may be further configured to determine the order allocation weight of the first service request with respect to the candidate service provider based on the grade of the candidate service provider, the estimated value of the first service request, the historical order parameters, and the expected order parameters of the candidate service provider.

In some embodiments, the at least one income threshold may include a first threshold and a second threshold, the second threshold being greater than or equal to the first threshold. To determine the grade of the candidate service provider based on a result of the comparison between the income deviation and the income threshold, the at least one processor may be configured to cause the system to determine the grade of the candidate service provider as a first grade based on a result of the comparison that the income deviation of the candidate service provider is less than the first threshold, determine the grade of the candidate service provider as a second grade based on a result of the comparison that the income deviation of the candidate service provider is greater than or equal to the first threshold and less than the second threshold, and determine the grade of the candidate service provider as a third grade based on a result of the comparison that the income deviation of the candidate service provider is greater than or equal to the second threshold.

In some embodiments, the grade of the candidate service provider may be determined as the first grade. To determine the order allocation weight of the first service request with respect to the candidate service provider, the at least one processor may be configured to cause the system to determine a plurality of value classes, each of the plurality of value class corresponding to a range of values, compare the estimated value of the first service request with the ranges of values of the plurality of value classes to determine a first value class of the first service request, determine a first historical proportion corresponding to the first value class based on a number count of historical orders belonging to the first value class and the number count of the historical orders of the candidate service provider, obtain a first expected proportion corresponding to the first value class based on the one or more expected order parameters, and determine the order allocation weight of the first service request with respect to the candidate service provider based on the first historical proportion corresponding to the first value class, the first expected proportion corresponding to the first value class, the estimated value of the first service request, the historical order parameters, and the expected order parameters of the candidate service provider.

In some embodiments, the grade of the candidate service provider is second grade. To determine the order allocation weight of the first service request with respect to the candidate service provider, the at least one processor is configured to cause the system to determine a plurality of value classes, each of the plurality of value class corresponding to a range of values, compare the estimated value of the first service request with the ranges of values of the plurality of value classes to determine a first value class of the first service request, determine at least one second value class from the plurality of value classes, wherein the range of values associated with the at least one second value class is greater than the range of values associated with the first value class, determine a first historical proportion corresponding to the first value class based on the number count of historical orders belonging to the first value class and the number count of the historical orders of the candidate service provider, obtain a first expected proportion corresponding to the first value class based on the one or more expected order parameters. The at least one processor is further configured to cause the system to, for each of the at least one second value class, determine a second historical proportion corresponding to the second value class based on the number count of historical orders belonging to the second value class and the number count of the plurality of historical orders, and obtain a second expected proportion corresponding to the second value class based on the one or more expected order parameters. The at least one processor is further configured to cause the system to determine the order allocation weight of the first service request with respect to the candidate service provider based on the first historical proportion corresponding to the first value class, the second historical proportions corresponding to the at least one second value class, the first expected proportion corresponding to the first value class, the second expected proportions corresponding to the at least one second value class, the estimated value of the first service request, the historical order parameters and the expected order parameters of the candidate service provider.

In some embodiments, the grade of the candidate service provider is third grade, and to determine the order allocation weight of the first service request with respect to the candidate service provider, the at least one processor is configured to cause the system to determine a plurality of value classes, each value class corresponding to a range of value. The at least one processor may be further configured to cause the system to, for each of the plurality of value classes, determine a historical proportion corresponding to the value class based on the number count of historical orders belonging to the value class and the number count of the historical orders of the candidate service provider, and obtain an expected proportion corresponding to the value class based on the one or more expected order parameters. The at least one processor may be further configured to cause the system to determine the order allocation weight of the first service request with respect to the candidate service provider based on a plurality of historical proportions and expected proportions corresponding to the plurality of value classes, the estimated value of the first service request, the historical order parameters and the expected order parameters of the candidate service provider.

In some embodiments, to determine the target service provider of the first service request from the at least one candidate service provider based on the at least one order allocation weight of the first service request with respect to the at least one candidate service provider, the at least one processor may be further configured to cause the system to, for each of the at least one second user device, receive a second service request, and determine at least one order allocation weight of the second service request with respect to the at least one candidate service provider. The at least one processor may be further configured to cause the system to construct a bipartite graph relating the first service request and the at least one second service request to the at least one candidate service provider, execute a bipartite graph matching algorithm on the bipartite graph to generate a matched bipartite graph based on the at least one order allocation weight of the first service request and each of the at least one second service request with respect to the at least one candidate service provider, and determine the target service provider of the first service request from the at least one candidate service provider based on the matched bipartite graph.

In some embodiments, the bipartite graph matching algorithm is at least one of Hungarian algorithm, Hopcroft-Karp algorithm, or Kuhn-Munkres algorithm.

According to another aspect of the present disclosure, a method is provided. The method may be implemented on a computing device having at least one storage device storing a set of instructions for allocating a service request to a service provider and at least one processor in communication with the at least one storage device. The method may include receiving a first service request, determining an estimated value of the first service request, and determining at least one candidate service provider for the first service request. The method may further include, for each of the at least one candidate service provider, obtaining one or more historical order parameters of the candidate service provider, receiving one or more expected order parameters of the candidate service provider, and determining an order allocation weight of the first service request with respect to the candidate service provider based on the estimated value of the first service request, the one or more historical order parameters, and the one or more expected order parameters of the service provider. The method may further include determining a target service provider of the first service request from the at least one candidate service provider based on at least one order allocation weight of the first service request with respect to the at least one candidate service provider.

According to another aspect of the present disclosure, a non-transitory computer readable medium is provided. The non-transitory computer readable medium may include at least one set of instructions for allocating a service request to a service provider. When executed by at least one processor of an electronic terminal, the at least one set of instructions directs the at least one processor to perform acts of receiving a first service request, determining an estimated value of the first service request, and determining at least one candidate service provider for the first service request. The at least one set of instructions may further directs the at least one processor to perform acts of for each of the at least one candidate service provider, obtaining one or more historical order parameters of the candidate service provider, receiving one or more expected order parameters of the candidate service provider, and determining an order allocation weight of the first service request with respect to the candidate service provider based on the estimated value of the first service request, the one or more historical order parameters, and the one or more expected order parameters of the service provider. The at least one set of instructions may further directs the at least one processor to perform acts of determining a target service provider of the first service request from the at least one candidate service provider based on at least one order allocation weight of the first service request with respect to the at least one candidate service provider.

According to another aspect of the present disclosure, a system is provided. The system may be implemented on a computing device having at least one storage device storing a set of instructions for allocating a service request to a service provider, and at least one processor in communication with the at least one storage device. The system may include an acquisition module, an estimated value determination module, a service provider determination module, a parameter obtaining module, a processing engine, and an order allocation module. The acquisition module may be configured to receive a first service request. The estimated value determination module may be configured to determine an estimated value of the first service request. The service provider determination module may be configured to determine at least one candidate service provider for the first service request. The parameter obtaining module may be configured to, for each of the at least one candidate service provider, obtain one or more historical order parameters of the candidate service provider, and receive one or more expected order parameters of the candidate service provider. The processing engine may be configured to determine an order allocation weight of the first service request with respect to the candidate service provider based on the estimated value of the first service request, the one or more historical order parameters, and the one or more expected order parameters of the service provider. The order allocation module may be configured to determine a target service provider of the first service request from the at least one candidate service provider based on at least one order allocation weight of the first service request with respect to the at least one candidate service provider.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online-to-offline service system according to some embodiments of the present disclosure;

FIG. 2 is a schematic diagram illustrating hardware and software components of an exemplary computing device according to some embodiments of the present disclosure;

FIG. 3 is a schematic diagram illustrating hardware and/or software components of an exemplary mobile device according to some embodiments of the present disclosure;

FIG. 4 is a block diagram illustrating an exemplary processing engine according to some embodiments of the present disclosure;

FIG. 5 is a flowchart illustrating an exemplary process for allocating a service request to a target service provider according to some embodiments of the present disclosure;

FIG. 6 is a flowchart illustrating an exemplary process for determining an order allocation weight associated with a service provider according to some embodiments of the present disclosure;

FIG. 7 is a flowchart illustrating an exemplary process for determining a grade of a service provider according to some embodiments of the present disclosure;

FIG. 8 is a flowchart illustrating an exemplary process for determining an order allocation weight associated with a service provider with a first grade according to some embodiments of the present disclosure;

FIG. 9 is a flowchart illustrating an exemplary process for determining an order allocation weight associated with a service provider with a second grade according to some embodiments of the present disclosure;

FIG. 10 is a flowchart illustrating an exemplary process for determining an order allocation weight associated with a service provider with a third grade according to some embodiments of the present disclosure;

FIG. 11 is an exemplary unmatched bipartite graph associated with service requests and service providers; and

FIG. 12 is an exemplary matched bipartite graph associated with service requests and service providers.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

It will be understood that the term “system,” “engine,” “unit,” “module,” and/or “block” used herein are one method to distinguish different components, elements, parts, section or assembly of different level in ascending order. However, the terms may be displaced by another expression if they may achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The system or method of the present disclosure may be applied to Online-to-offline systems of different environments including land, ocean, aerospace, or the like, or any combination thereof. The vehicle of the online-to-offline systems may include a taxi, a private car, a hitch, a bus, a train, a bullet train, a high-speed rail, a subway, a vessel, an aircraft, a spaceship, a hot-air balloon, a driverless vehicle, or the like, or any combination thereof.

The term “passenger,” “requester,” “service requester,” and “customer” in the present disclosure are used interchangeably to refer to an individual, an entity or a tool that may request or order a service. The term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger,” “user equipment,” “user terminal,” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The present disclosure relates to systems and methods for allocating service requests in an online-to-offline service system. For example, the online-to-offline service system may be a car-hailing service system facilitating car-hailing services. A passenger (or service requester) may transmit a car-hailing request to the car-hailing service system. The car-hailing service system may determine a plurality of service providers. For example, the system may determine a plurality of service providers who may be available to pick up the passenger and/or close to the passenger. The car-hailing service system may also determine an order allocation weight corresponding to each of the plurality of the service providers. The service provider with the highest order allocation weight may be selected as a target service provider, and the car-hailing request may be transmitted to a user terminal associated with the target service provider (e.g., a smartphone). In some embodiments, multiple car-hailing requests may be distributed to multiple service providers. For example, order allocation weights between car-hailing requests and service providers may be determined, and a bipartite graph may be constructed based on the service requests, the service providers, and the order allocation weights. A match (e.g., a complete match) of the bipartite graph may be searched, and the target service provider corresponding to each of the multiple service requests may be determined based on the match of the bipartite graph. The service requests may each be transmitted to a corresponding service provider.

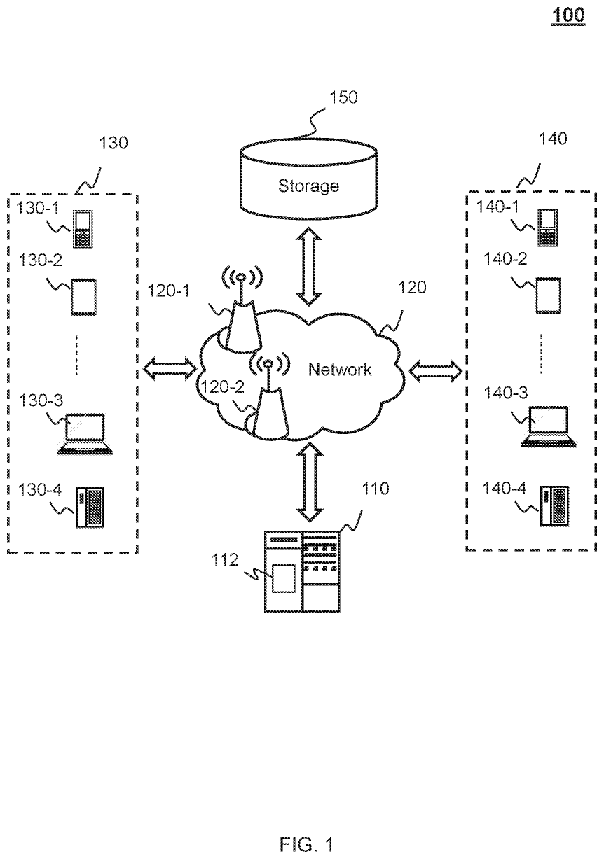

FIG. 1 is a schematic diagram illustrating an exemplary Online-to-offline service system 100 according to some embodiments of the present disclosure. The online-to-offline service system 100 may include a server 110, a network 120, a service requester terminal 130, a service provider terminal 140, and a storage 150.

For example, the online-to-offline service system 100 may be an online transportation service platform for transportation services. The transportation services may include but not limited to car-hailing service, chauffeur service, express car service, carpool service, bus service, driver hire service, or shuttle service. In some embodiments, the online-to-offline service system 100 may provide other types of services including but not limited to a delivery service, a navigation service, a booking service, a shopping service, an inquiry service, or the like, or any combination thereof.

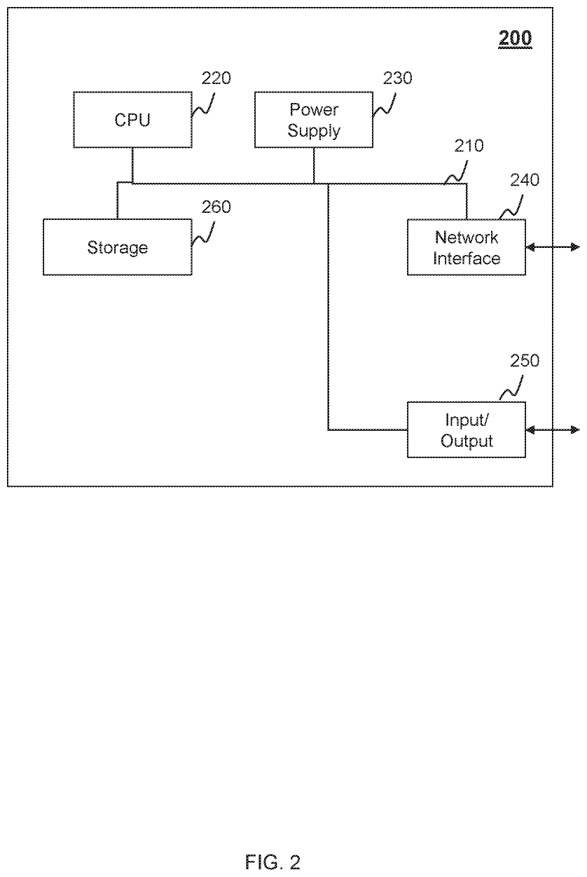

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service requester terminal 130, the service provider terminal 140, and/or the storage 150 via the network 120. As another example, the server 110 may be directly connected to the service requester terminal 130, the service provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may receive a service request from a service requester terminal 130 and determine at least one candidate service provider based on the service request. The processing engine 112 may also select a target service provider from the at least one candidate service provider and transmit the service request to a target service provider terminal 140 associated with the target service provider. As another example, the processing engine 112 may receive a plurality of service requests from a plurality of service requester terminals 130. The processing engine 112 may also determine a plurality of service providers and allocate the plurality of service requests to a plurality of service provider terminals 140 associated with the plurality of service providers on a one-to-one, one-to-many, or many-to-one basis. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof. In some embodiments, the processing engine 112 may realize one or more functions described in the present disclosure by logic circuits thereof.

The network 120 may facilitate exchange of information and/or data. In some embodiments, one or more components of the online-to-offline service system 100 (e.g., the server 110, the service requester terminal 130, the service provider terminal 140, and the storage 150) may transmit information and/or data to other component(s) of the online-to-offline service system 100 via the network 120. For example, the processing engine 112 may receive a service request from the service requester terminal 130 via the network 120. As another example, the processing engine 112 may transmit a service request to the service provider terminal 140 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points.

For example, the network 120 may include wired or wireless network access points such as base stations and/or internet exchange points 120-1, 120-2, . . . , through which one or more components of the online-to-offline service system 100 may be connected to the network 120 to exchange data and/or information.

In some embodiments, a passenger may be an owner of the service requester terminal 130. In some embodiments, the owner of the service requester terminal 130 may be someone other than the passenger. For example, an owner A of the service requester terminal 130 may use the service requester terminal 130 to transmit a service request for a passenger B or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably.

In some embodiments, the service requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the service requester terminal 130 may be a device with positioning technology (e.g., through a global positioning system (GPS) chipset) for locating the position of the passenger and/or the service requester terminal 130.

The service provider terminal 140 may include a plurality of service provider terminals 140-1, 140-2, . . . , 140-n. In some embodiments, the service provider terminal 140 may be similar to, or the same as the service requester terminal 130. In some embodiments, the service provider terminal 140 may be customized to be able to implement the online-to-offline transportation service. In some embodiments, the service provider terminal 140 may be a device with positioning technology (e.g., through a global positioning system (GPS) chipset) for locating the service provider and/or the service provider terminal 140. In some embodiments, the service requester terminal 130 and/or the service provider terminal 140 may communicate with another positioning device to determine the position of the passenger, the service requester terminal 130, the service provider, and/or the service provider terminal 140. In some embodiments, the service requester terminal 130 and/or the service provider terminal 140 may periodically transmit the positioning information to the server 110. In some embodiments, a service provider terminal 140 may also periodically transmit the availability status to the server 110. The availability status may indicate whether the service provider terminal 140 is available to accept a service request. For example, the service requester terminal 130 and/or the service provider terminal 140 may transmit the positioning information and the availability status to the server 110 every thirty minutes. As another example, the service requester terminal 130 and/or the service provider terminal 140 may transmit the positioning information and the availability status to the server 110 each time the user logs into the mobile application associated with the online-to-offline transportation service. In some embodiments, the server 110 may transmit a connection request to the terminal (e.g., the service requester terminal 130 and/or the service provider terminal 140) that is available to accept a service request, and establish a connection with the terminal after the connection request is accepted by the terminal. In some embodiments, the terminal may transmit a connection request to the server and establish a connection with the server after the connection request is accepted by the server. It should be noted that the communication between the server and the terminal may refer to direct communication between them or communication between the applications installed on them.

The storage 150 may store data and/or instructions. In some embodiments, the storage 150 may store data obtained from the service requester terminal 130 and/or the service provider terminal 140. In some embodiments, the storage 150 may store data and/or instructions that the server 110 may execute or use to perform exemplary methods described in the present disclosure. In some embodiments, storage 150 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include random-access memory (RAM). Exemplary RAM may include a dynamic RAM (DRAM), a double data rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 150 may be implemented on a cloud platform.

Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the online-to-offline service system 100 (e.g., the server 110, the service requester terminal 130, or the service provider terminal 140). One or more components of the online-to-offline service system 100 may access the data or instructions stored in the storage 150 via the network 120. In some embodiments, the storage 150 may be directly connected to or communicate with one or more components of the online-to-offline service system 100 (e.g., the server 110, the service requester terminal 130, the service provider terminal 140). In some embodiments, the storage 150 may be part of the server 110.

In some embodiments, one or more components of the online-to-offline service system 100 (e.g., the server 110, the service requester terminal 130, the service provider terminal 140) may have permissions to access the storage 150. In some embodiments, one or more components of the online-to-offline service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components of the online-to-offline service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in the software of a mobile terminal, a program, a system, or the like, or any combination thereof. The mobile terminal may include a tablet computer, a laptop computer, a mobile phone, a personal digital assistant (PDA), a smartwatch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the online-to-offline service system 100 performs, the element may perform through electrical signals and/or electromagnetic signals. For example, when a service requester terminal 130 transmits out a service request to the server 110, a processor of the service requester terminal 130 may generate an electrical signal encoding the request. The processor of the service requester terminal 130 may then transmit the electrical signal to an output port. If the service requester terminal 130 communicates with the server 110 via a wired network, the output port may be physically connected to a cable, which further may transmit the electrical signal to an input port of the server 110. If the service requester terminal 130 communicates with the server 110 via a wireless network, the output port of the service requester terminal 130 may be one or more antennas, which convert the electrical signal to electromagnetic signal. Similarly, a service provider terminal 140 may receive an instruction and/or service request from the server 110 via electrical signal or electromagnet signals. Within an electronic device, such as the service requester terminal 130, the service provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the service requester terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an online-to-offline service system for the present disclosure. The computing device 200 may implement any component of the online-to-offline service as described herein. In FIGS. 1-2, only one such computer device is shown purely for convenience purposes. One of ordinary skill in the art would understand that the computer functions relating to the online-to-offline service as described herein may be implemented in a distributed fashion on a number of similar platforms, to distribute the processing load.

The computing device 200, for example, may include a network interface 240 connected to and from a network (e.g., the network 120) connected thereto to facilitate data communications. The computing device 200 may also include a central processing unit (CPU, or processor) 220, in the form of one or more processors, for executing program instructions. The exemplary computer platform may include an internal communication bus 210, program storage and a storage 260. The storage 260 may be of different forms, for example, a disk, and a read-only memory (ROM), or random-access memory (RAM), for various data files to be processed and/or transmitted by the computing device 200. The computing device 200 may also include program instructions stored in the ROM, the RAM, and/or another type of non-transitory storage medium to be executed by the CPU/processor 220. The methods and/or processes of the present disclosure may be implemented as the program instructions. The computing device 200 may also include an input/output component 250, supporting input/output between the computer and other components therein. The computing device 200 may also receive programming and data via network communications.

Merely for illustration, only one CPU/processor 220 is described in the computing device 200. However, it should be noted that the computing device 200 in the present disclosure may also include multiple CPUs/processors. Thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B). The power supply 230 may supply power to the components of the computing device 200.

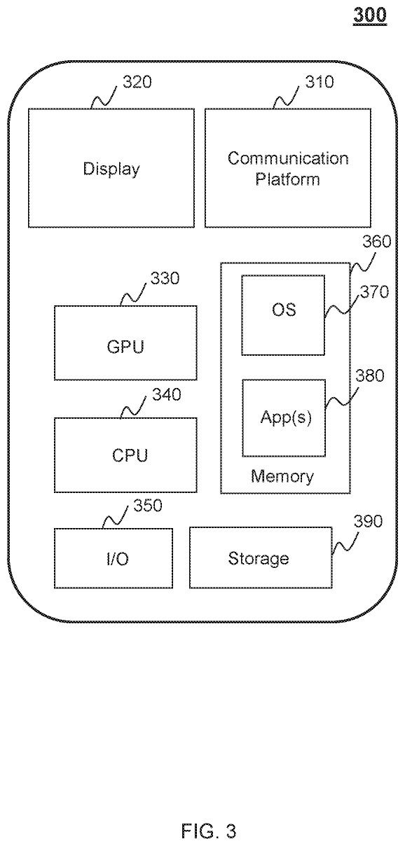

FIG. 3 is a schematic diagram illustrating exemplary hardware and/or software components of an exemplary mobile device 300 on which a user terminal may be implemented according to some embodiments of the present disclosure. As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to Online-to-offline service or other information from the processing engine 112. User interactions with the information stream may be achieved via the I/O 350 and provided to the processing engine 112 and/or other components of the online-to-offline service system 100 via the network 120. In some embodiments, the mobile device 300 may transmit (or receive) a connection request to the server 110 via a network 120 and establish a connection with the server 110 after the connection request is accepted by the server 110 (or the mobile device 300). After the connection between the server 110 and the mobile device 300 is established, the server 110 may communicate with the application(s) 380 installed on the mobile device 300 to transmit or receive information or data (e.g., service request, information of service provider or service requester).

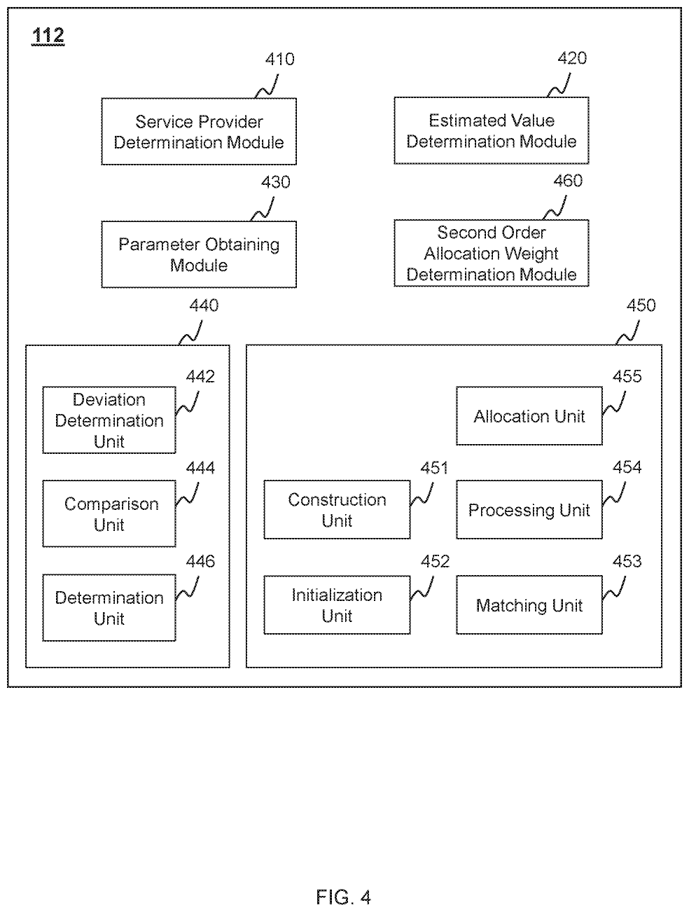

FIG. 4 is a block diagram illustrating an exemplary processing engine according to some embodiments of the present disclosure. The processing engine 112 may include a service provider determination module 410, an estimated value determination module 420, a parameter obtaining module 430, a first order allocation weight determination module 440, an order allocation module 450, and a second order allocation weight determination module 460. Each of the modules described above may be a hardware circuit that is designed to perform certain actions, e.g., according to a set of instructions stored in one or more storage media, and/or any combination of the hardware circuit and the one or more storage media.

The service provider determination module 410 may be configured to determine at least one candidate service provider (also referred to as a service provider) associated with a service request received from a service requester. The service request may include a car-hailing service request, a food delivery service request, etc. In some embodiments, the service provider determination module 410 may determine at least one candidate service provider based on the location of the service requester. For example, the service provider determination module 410 may determine some or all of the service providers in a region around the location of the service requester as the candidate service provider(s). The region may be a circular region centered at the location of the service requester with a radius of a predetermined distance. Alternatively, the region may be a rectangular or square region having the location of the service requester as the center thereof.

The estimated value determination module 420 may be configured to determine an estimated value of a service request from a service requester. In some embodiments, the estimated value determination module 420 may determine the estimated value of the service request based on an estimated price of the service request. Alternatively, the estimated value determination module 420 may determine the estimated value of the service request based on various parameters.

Take a car-hailing service as an example. The parameters for determining the estimated value of a service request may include the estimated price of the service request, the estimated time length of completing the service request, the price increase of the service request, traffic conditions (e.g., congestion degree) of the route corresponding to the service request, the response probability of service providers (e.g., the ratio between the number of service providers responding to the service request and the number of service providers receiving the service request), the cancellation probability of service providers after responding to the service request, or the estimated time length before the pick-up of the service requester (i.e., the time that a service provider takes to reach the pick-up location of the service requester), or the like.

The parameter obtaining module 430 may be configured to obtain one or more historical order parameters and one or more expected order parameters associated with each of the at least one candidate service provider. In some embodiments, the one or more historical order parameters may be determined based on historical orders that a candidate service provider completed in the past, which may be stored in a storage (e.g., a storage 150) or a database. The one or more expected order parameters may be set automatically by the online-to-offline service system 100 or manually by the at least one candidate service provider.

The first order allocation weight determination module 440 may be configured to determine an order allocation weight based on an income deviation of the candidate service provider, one or more historical order parameters, one or more expected order parameters, and/or the estimated value of the service request. In some embodiments, when the historical online time length T of a candidate service provider is greater than or equal to an online time threshold, the first order allocation weight determination module 440 may be employed to determine the order allocation weight associated with the candidate service provider. However, when the historical online time length T of a candidate service provider is less than the online time threshold, the second order allocation weight determination module 460 may be employed to determine the order allocation weight associated with the candidate service provider.

In some embodiments, the first order allocation weight determination module 440 may include a deviation determination unit 442, a comparison unit 444, and a determination unit 446. Each unit may be a hardware circuit that is designed to perform certain actions, e.g., according to a set of instructions stored in one or more storage media, and/or any combination of the hardware circuit and the one or more storage media.

The deviation determination unit 442 may be configured to determine an income deviation for each of the at least one candidate service provider based on the one or more historical order parameters and the one or more expected order parameters. The income deviation may represent a deviation or difference between an actual income and an expected income of the candidate service provider. A higher income deviation may represent a larger difference between the actual income and the expected income of the candidate service provider.

In some embodiments, the deviation determination unit 442 may include a judgment sub-unit and a first determination sub-unit (not shown in the figure).

The judgment sub-unit may be configured to determine whether a historical online time length T is greater than or equal to an online time threshold. The first determination sub-unit may be configured to determine an income deviation of a candidate service provider based on the one or more historical order parameters and/or the one or more expected order parameters when the historical online time length T is greater than or equal to the online time threshold.

When a historical online time length T of a candidate service provider is greater than or equal to the online time threshold, the deviation determination unit 442 may determine the income deviation of the service based on the one or more historical order parameters and/or the one or more expected order parameters.

The comparison unit 444 may be configured to compare an income deviation of each of the at least one candidate service provider with at least one preset income threshold.

The determination unit 446 may be configured to determine the order allocation weight of the service request based on the comparison result, the one or more historical order parameters, the one or more expected order parameters, and/or the estimated value of the service request.

In some embodiments, the determination unit 446 may include a first value class determination sub-unit, a first acquisition sub-unit, and a second determination sub-unit (not shown in the figure). The first value class determination sub-unit may be configured to determine which value class a service request belongs to based on the estimated value V of the service request and a plurality of ranges of values corresponding to a plurality of value classes. The first acquisition sub-unit may be configured to obtain a historical proportion r and an expected proportion R corresponding to the value class that the service request belongs to. The second determination sub-unit may be configured to determine the order allocation weight of the service request with respect to the each of the at least one candidate service provider based on the historical proportion r, the expected proportion R, the one or more historical order parameters, the one or more expected order parameters and/or the estimated value V.

In some embodiments, the determination unit 446 may include a second value class determination sub-unit, a second acquisition sub-unit, and a third determination sub-unit (not shown in the figure). The second value class determination sub-unit may be configured to determine which value class the service request belongs to based on the estimated value V of the service request when the income deviation is not less than the first income threshold and is less than a second income threshold. The second acquisition sub-unit may be configured to obtain a historical proportion r and an expected proportion R corresponding to the value class that the service request belongs to and obtain a historical proportion r′ and an expected proportion R′ corresponding to at least one value class that is higher than the value class that the service request belongs to. The third determination sub-unit may be configured to determine the order allocation weight of the order with respect to the each of the at least one candidate service provider based on the historical proportion r, the expected proportion R, the historical proportion r′, the expected proportion R′, the one or more historical order parameters, the one or more expected order parameters and the estimated value V.

In some embodiments, the determination unit 446 may include a third acquisition sub-unit, and a fourth determination sub-unit (not shown in the figure). The third acquisition sub-unit may be configured to obtain historical proportions {r₁, . . . , rₙ} and expected proportions {R₁, . . . Rₙ} corresponding to each value class. The fourth determination sub-unit may be configured to determine the order allocation weight of the order with respect to each of the at least one candidate service provider based on the historical proportions {r₁, . . . , rₙ}, the expected proportions {R₁, . . . , Rₙ}, the one or more historical order parameters, the one or more expected order parameters, and/or the estimated value V of the service request.

The order allocation module 450 may be configured to allocate a service request to a target service provider from the at least one candidate service provider. In some embodiments, the order allocation module 450 may be configured to allocate a plurality of service requests to a plurality of service providers. In some embodiments, the order allocation module 450 may further include a construction unit 451, an initialization unit 452, a matching unit 453, a processing unit 454, and an allocation unit 455. Each unit may be a hardware circuit that is designed to perform certain actions, e.g., according to a set of instructions stored in one or more storage media, and/or any combination of the hardware circuit and the one or more storage media.

The construction unit 451 may be configured to construct a bipartite graph based on at least one service requester, at least one candidate service provider, and at least one order allocation weight.

The initialization unit 452 may be configured to initialize values of one or more vertices in the bipartite graph.

The matching unit 453 may be configured to find a match (e.g., a complete match) of the bipartite graph using the Hungarian algorithm.

The processing unit 454 may be configured to, if no match is found for the bipartite graph, modify the values of the one or more vertices in the bipartite graph and continually find the match of the bipartite graph using the Hungarian algorithm until the match is found. The match may meet at least one of the following conditions: each service request corresponds to only one service provider; each service provider corresponds to only one service request; as many as possible service requests find a matched service provider, and the sum of order allocation weight corresponding to matched service requests and service providers is as high as possible.

The allocation unit 455 may be configured to allocate a service request of a service requester to a target service provider from the at least one candidate service provider based on at least one order allocation weight of the at least one candidate service provider. The allocation unit 455 may be further configured to allocate a plurality of service requests to a plurality of service providers based on the match (e.g., the complete match) of the bipartite graph.

The second order allocation weight determination module 460 may be configured to, when a historical online time length T of a service provider of the at least one candidate service provider is less than the online time threshold, determine the order allocation weight of the service request with respect to each of the at least one candidate service provider based on the one or more historical order parameters, the one or more expected order parameters, and/or the estimated value of the service request.

It should be noted that the above descriptions of the processing engine 112 is provided for the purposes of illustration, and not intended to limit the scope of the present disclosure. For a person having ordinary skill in the art, various modifications and changes in the forms and details of the application of the above method and system may occur without departing from the principles of the present disclosure. However, those variations and modifications also fall within the scope of the present disclosure. In some embodiments, the processing engine 112 may include one or more other modules. For example, the processing engine 112 may include a storage module to store data generated by the modules in the processing engine 112. In some embodiments, any two of the modules may be combined as a single module, and any one of the modules may be divided into two or more units.

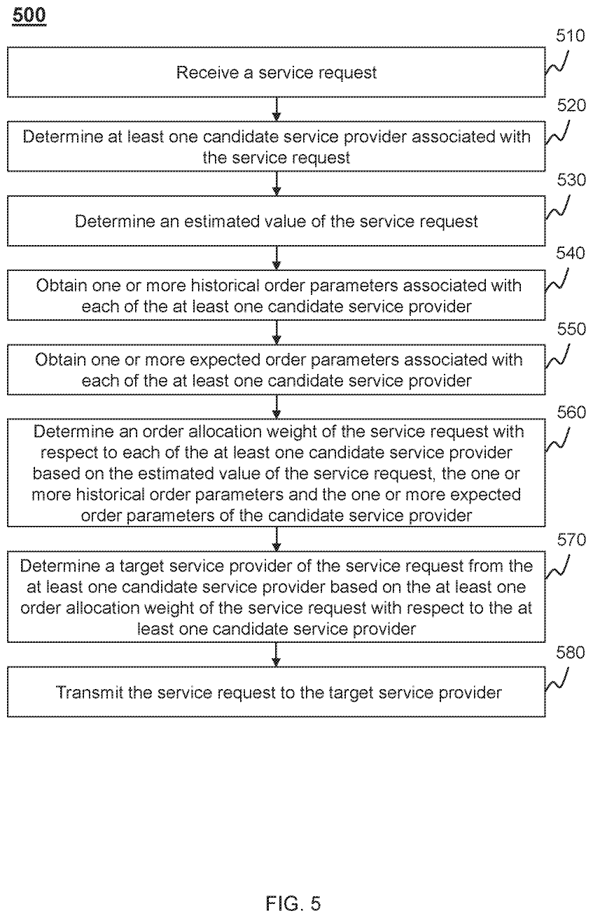

FIG. 5 is a flowchart illustrating an exemplary process for allocating a service request to a target service provider according to some embodiments of the present disclosure. In some embodiments, process 500 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 500. The operations of the illustrated process present below are intended to be illustrative. In some embodiments, process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112 may receive a service request. The service request may include a car-hailing service request, a food delivery service request, etc. In some embodiments, the processing engine 112 may receive the service request from the service requester terminal 130 after the server 110 is connected with the service requester terminal 130. The service requester terminal 130 may transmit a connection request to the server 110, which may establish a connection with the service requester terminal 130 if the connection request is accepted by the server. The communication between the server and the terminal may be direct communication between them or communication between the applications thereof.

In 520, the processing engine 112 (e.g., the service provider determination module 410) may determine at least one candidate service provider for the service request. In some embodiments, the processing engine 112 may determine at least one candidate service provider based on the location of the service requester. For example, the processing engine 112 may determine some or all of the service providers in a region around the location of the service requester as the candidate service provider(s). The region may be a circular region centered at the location of the service requester with a radius of a predetermined distance. Alternatively, the region may be a rectangular or square region having the location of the service requester as the center thereof.

The above descriptions of the region for determining one or more candidate service requesters is merely provided for illustration purposes, and the shape and/or size of the region is not limited in the present disclosure.

In 530, the processing engine 112 (e.g., estimated value determination module 420) may determine an estimated value of the service request. In some embodiments, the processing engine 112 (e.g., estimated value determination module 420) may determine the estimated value of the service request based on an estimated price of the service request. In some embodiments, the processing engine 112 (e.g., estimated value determination module 420) may determine the estimated value of the service request based on various parameters.

Take a car-hailing service as an example. The parameters for determining the estimated value of a service request may include the estimated price of the service request, the estimated time length of completing the service request, the price increase of the service request (e.g., price increase during rush hours, tips), traffic conditions (e.g., congestion degree) of the route corresponding to the service request, the response probability of service providers (e.g., the ratio between the number of service providers responding to the service request and the number of service providers receiving the service request), the cancellation probability of service providers after responding to the service request, or the estimated time length before the pick-up of the service requester (i.e., the time that a service provider takes to reach the pick-up location of the service requester), or the like.

For example, the processing engine 112 may determine the estimated value of a service request as: w1*the response probability of a driver+w2*the estimated price of the service request+w3*the cancellation probability of a driver after responding to the service request, where w1 is the weight of the response probability of the driver, w2 is the weight of the estimated price of the service request, and w3 is the weight of the cancellation probability of service providers after responding to the service request. As another example, the processing engine 112 (e.g., estimated value determination module 420) may determine the estimated value of a service request by dividing the estimated price of the service request by the sum of the estimated time length before the pick-up of the service requester and the estimated time length of the service request. It should be noted that the above descriptions of the determination of the estimated value of the service request is merely provided for illustration purposes, and do not intend to limit the scope of the present disclosure.

In 540, the processing engine 112 (e.g., the parameter obtaining module 430) may obtain one or more historical order parameters associated with each of the at least one candidate service provider. In some embodiments, the one or more historical order parameters may be determined based on historical orders that a candidate service provider completed in the past, which may be stored in a storage (e.g., a storage 150) or a database.

Take a car-hailing service as an example. The one or more historical order parameters may include a historical online time length T, the total value S of historical orders (all historical orders that the service provider completed, or the historical orders completed within a certain period), the value structure of historical orders, or the like, or any combination thereof. In some embodiments, the historical online time length T may include only the time length of the service provider (e.g., the driver) for performing historical service requests. Alternatively, the historical online time length T may include both the time length for waiting for the historical service requests and the time length for performing the historical service requests. The total value S of historical orders may represent the total value of all historical orders completed by the service provider (e.g., a driver), or the total income earned by the service provider. The value structure of historical orders may represent historical proportions of different values of the historical orders and may be determined based on values of the historical orders. For example, the value structure of historical orders may include n value classes and proportions r, each of which corresponds to one of the n value classes. Each of the n value classes may include a value range. The value ranges corresponding to the n value classes may overlap or not. A historical order may be classified into one of the n value classes if the value of the historical order falls into a value range corresponding to the value class. The historical proportion r corresponding to each of the n value classes may be determined by dividing the number of historical orders belonging to a value class by the total number of the historical orders. For example, the value structure of historical orders may include three value classes, namely, value classes A, B, and C. Historical orders may be classified into one of the three classes according to the value ranges in which the values of historical orders fall. For example, the processing engine 112 may specify a first value threshold and a second value threshold. The second value threshold may be greater than the first value threshold, and both thresholds may be greater than zero. Historical orders with a value lower than the first value threshold may be classified into a first value class (e.g., value class C). Historical orders with a value greater than or equal to a first value threshold and less than a second value threshold may be classified into a second value class (e.g., value class B). Historical orders with a value greater than or equal to the second value threshold may be classified into a third value class (e.g., value class A). The historical proportion r corresponding to the each of the three value classes may be determined by dividing the number of historical orders belonging to the value class by the total number of the historical orders. For example, the value structure of the historical orders may include that a historical proportion r of the first value class being 20%, a historical proportion r of the second value class being 60%, and/or a historical proportion r of the third value class being 20%.

In 550, the processing engine 112 (e.g., the parameter obtaining module 430) may obtain one or more expected order parameters associated with each of the at least one candidate service provider. Take a car-hailing service as an example. The one or more expected order parameters may include an expected income at unit time P, a value structure of expected orders, or the like, or any combination thereof. The expected income at unit time P may represent an expected income at the unit time (e.g., a certain amount per hour) of a service provider (e.g., a driver). The value structure of expected orders may represent an expected value structure of the service provider (e.g., a driver). The value structure of expected orders may include n value classes and n expected proportions R corresponding to each of the n value classes. For example, the value structure of expected orders of the service provider may include that an expected proportion R of the first value class being 30%, the expected proportion R of the second value class being 60%, and the expected proportion R of the third value class being 10%.

In some embodiments, the one or more expected order parameters may be set automatically by the online-to-offline service system 100 or manually by the service provider. For example, a questionnaire associated with expected order parameters may be given to a plurality of service providers, and statistically analyzed to obtain the one or more expected order parameters. In some embodiments, the online-to-offline service system 100 may determine a higher expected income at a unit time for a service provider with a higher service rating.

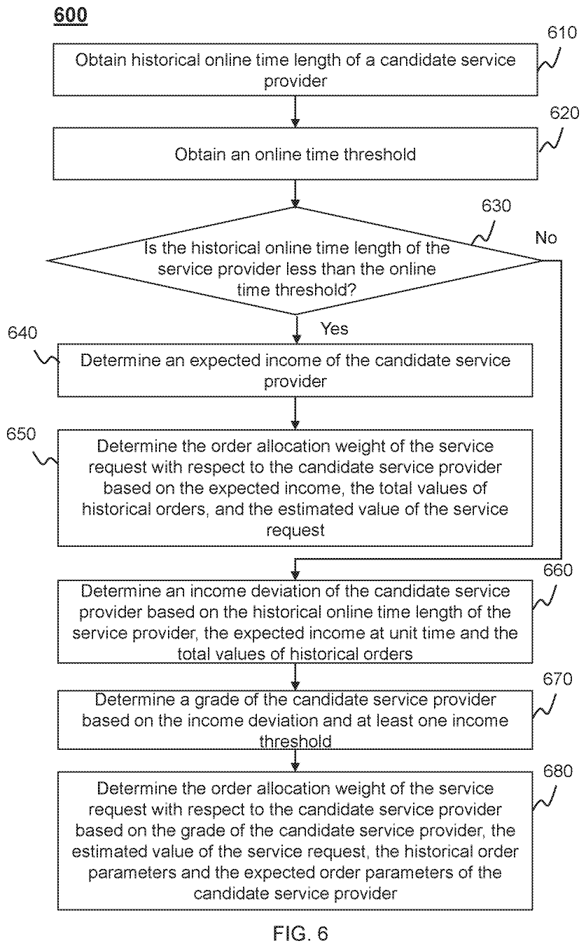

In 560, the processing engine 112 may determine an order allocation weight of the service request with respect to each of the at least one candidate service provider based on the estimated value of the service request, the one or more historical order parameters, and/or the one or more expected order parameters of the service provider. In some embodiments, the processing engine 112 (e.g., the first order allocation weight determination module 440) may determine the order allocation weight based on an income deviation of the service provider, the one or more historical order parameters, the one or more expected order parameters, and/or the estimated value of the service request when a historical online time length T of a service provider is greater than or equal to an online time threshold. In some embodiments, the processing engine 112 (e.g., the second order allocation weight determination module 460) may determine the order allocation weight based on the one or more historical order parameters, the one or more expected order parameters, and/or the estimated value of the service request when a historical online time length T of a service provider is less than the online time threshold. Detailed descriptions regarding the determination of the order allocation weight may be found elsewhere in the present disclosure (e.g., FIGS. 6 and 8-10, and descriptions thereof).

In 570, the processing engine 112 (e.g., the order allocation module 450) may determine a target service provider for the service request from the at least one candidate service provider based on the at least one order allocation weight of the service request with respect to the at least one candidate service provider.

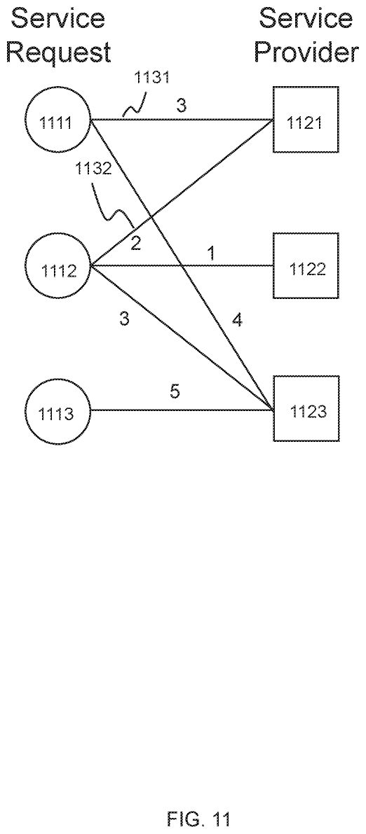

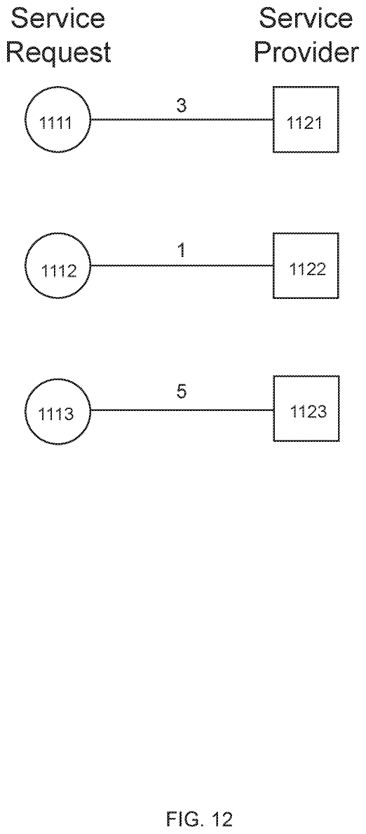

In some embodiments, the processing engine 112 (e.g., the order allocation module 450) may determine the candidate service provider with the highest order allocation weight as the target service provider for the service request. In some embodiments, the processing engine 112 (e.g., the order allocation module 450) may determine the target service provider for the service request by finding a match (e.g., a complete match) of a bipartite graph associated with service requests, service providers, and order allocation weights associated with the service providers with respect to the service requests. Detailed descriptions regarding the search of the match of a bipartite graph may be found elsewhere in the present disclosure (e.g., FIGS. 11 and 12, and descriptions thereof).

In 580, the processing engine 112 may transmit the service request to the target service provider. In some embodiments, the processing engine 112 may transmit the service request to the terminal of the target service provider (e.g., the service provider terminal 140). For example, the processing engine 112 may display at least portion of information relating to the service request on a graphic user interface (GUI) of the terminal of the target service provider by communicating with the service providing application executing on the terminal of the target service provider via a communication port of the terminal of the target service provider. Take a car-hailing service as an example; the information relating to the service request may include the pick-up location of the service requester, the departure time of the service request, the destination of the service request, etc.

FIG. 6 is a flowchart illustrating an exemplary process for determining an order allocation weight associated with a service provider according to some embodiments of the present disclosure. In some embodiments, process 600 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 600. The operations of the illustrated process present below are intended to be illustrative. In some embodiments, process 600 may be accomplished with one or more additional operations not described and/or without one or more of the operations herein discussed. Additionally, the order in which the operations of the process as illustrated in FIG. 6 and described below is not intended to be limiting. In some embodiments, operation 560 of process 500 may be performed according to process 600.

In 610, the processing engine 112 (e.g., the parameter obtaining module 430) may obtain historical online time length T of a service provider (e.g., a candidate service provider). In some embodiments, the historical online time length T may include only the time length of the service provider (e.g., the driver) for performing historical service requests. Alternatively, the historical online time length T may include both the time length for waiting for the historical service requests and the time length for performing the historical service requests.

In 620, the processing engine 112 may obtain an online time threshold. In some embodiments, the online time threshold may be a preset threshold set by the server 110 or obtained from the network 120 or the storage 150. The online time threshold may be 100 hours, 200 hours, 500 hours, 1000 hours, etc.

In 630, the processing engine 112 may determine whether the historical online time length T of the service provider is less than the online time threshold. In response to the determination that the historical online time length T of the service provider is less than the online time threshold, process 600 may proceed to 640; otherwise, process 600 may proceed to 660.

In 640, the processing engine 112 (e.g., the second order allocation weight determination module 460) may determine an expected income of the service provider. In some embodiments, the processing engine 112 (e.g., the second order allocation weight determination module 460) may determine the expected income of the service provider by multiplying the expected income at unit time P of the service provider by the expected time length of the service request T.

In 650, the processing engine 112 (e.g., the second order allocation weight determination module 460) may determine the order allocation weight of the service request with respect to the service provider based on the expected income, the total values S of historical orders, and the estimated value V of the service request. In some embodiments, the processing engine 112 (e.g., the second order allocation weight determination module 460) may determine the order allocation weight of the service request with respect to the service provider based on a fourth weight determination algorithm. The fourth weight determination algorithm may be expressed as follows:

$${e}^{- {( \frac{P \times T - S - V}{P \times T - S} )}^{2}} , \qquad ( 1 )$$

where P denotes an expected income at the unit time of a service provider; T denotes a historical online time length of the service provider; S denotes the total value of all historical orders of the service provider; and V denotes an estimated value of the service request.

In 660, the processing engine 112 (e.g., the first order allocation weight determination module 440) may determine an income deviation of the service provider based on the historical online time length T of the service provider, the expected income at unit time P and the total values S of historical orders. The income deviation may represent the deviation or difference between an actual income and an expected income of the service provider. A higher income deviation may represent a larger difference between the actual income and the expected income of the service provider.

In some embodiments, the processing engine 112 (e.g., the first order allocation weight determination module 440) may determine the income deviation of the service provider based on the historical online time length T of the service provider, the expected income at unit time P, and/or the total values S of historical orders using a predetermined income deviation algorithm. The predetermined income deviation algorithm may be expressed as follows:

$$Income deviation = \frac{P \times T - S}{P \times T} \times 100 \% , , \qquad ( 2 )$$

where P denotes an expected income at the unit time of a service provider; T denotes the historical online time length of the service provider; and S denotes the total value of all historical orders of the service provider.

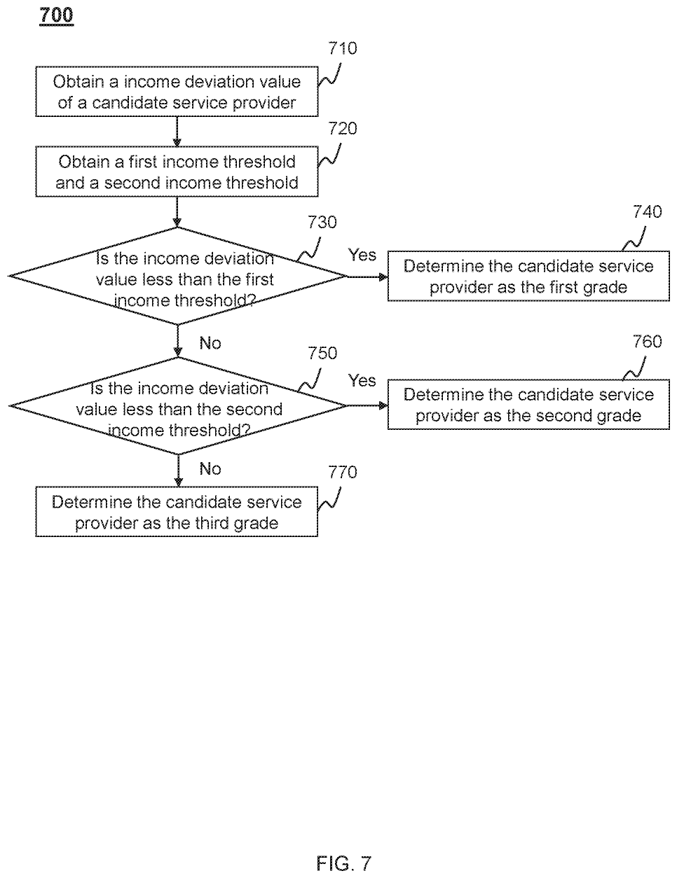

In 670, the processing engine 112 (e.g., the first order allocation weight determination module 440) may determine the grade of the service provider based on the income deviation and at least one income threshold. Detailed descriptions regarding the determination of grade of the service provider may be found elsewhere in the present disclosure (e.g., FIG. 7 and descriptions thereof).

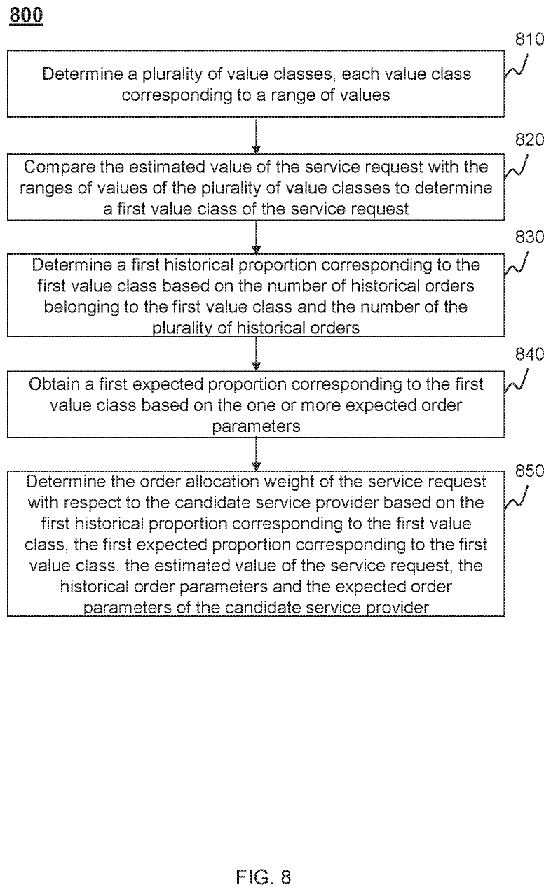

In 680, the processing engine 112 (e.g., the first order allocation weight determination module 440) may determine the order allocation weight of the service request with respect to the service provider based on the grade of the service provider, the estimated value V of the service request, the historical order parameters, and/or the expected order parameters of the service provider. Detailed descriptions regarding the determination of order allocation weight with respect to the service provider at different grade may be found elsewhere in the present disclosure (e.g., FIGS. 8-10 and descriptions thereof).

It should be noted that the above descriptions of process 600 are provided for the purposes of illustration, and not intended to limit the scope of the present disclosure. For a person having ordinary skill in the art, various modifications and changes in the forms and details of the application of the above method and system may occur without departing from the principles in the present disclosure. However, those variations and modifications also fall within the scope of the present disclosure. For example, operation 630 may be omitted, and either operations 640-650 or operations 660-680 may be performed regardless of whether the historical online time length of the service provider is less than, equal to, or greater than the online time threshold.

FIG. 7 is a flowchart illustrating an exemplary process for determining the grade of a service provider according to some embodiments of the present disclosure. In some embodiments, process 700 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 700. The operations of the illustrated process present below are intended to be illustrative. In some embodiments, process 700 may be accomplished with one or more additional operations not described and/or without one or more of the operations herein discussed. Additionally, the order in which the operations of the process as illustrated in FIG. 7 and described below is not intended to be limiting. In some embodiments, operations 660 and 670 of process 600 may be performed according to process 700.

In 710, the processing engine 112 may obtain an income deviation of a service provider (e.g., a candidate service provider). The income deviation of the service provider may be determined according to operation 660 of process 600 in FIG. 6.

In 720, the processing engine 112 may obtain a first income threshold and a second income threshold. In some embodiments, the first income threshold and the second income threshold may be set by the server 110, and the first income threshold may be lower than the second income threshold.

In 730, the processing engine 112 (e.g., the first order allocation weight determination module 440) may determine whether the income deviation of the service provider is less than the first income threshold. If the processing engine 112 determines that the income deviation is less than the first income threshold, process 700 may proceed to 740; otherwise, process 700 may proceed to 750. In 740, the processing engine 112 may determine the service provider has the first grade. If the service provider is determined as having the first grade, the processing engine 112 (e.g., the first order allocation weight determination module 440) may determine the order allocation weight of the service provider according to process 800 described in connection with FIG. 8.

In 750, the processing engine 112 (e.g., the first order allocation weight determination module 440) may determine whether the income deviation is less than the second income threshold. If the processing engine 112 determines that the income deviation is less than the second income threshold, process 700 may proceed to 760; otherwise, process 700 may proceed to 770.

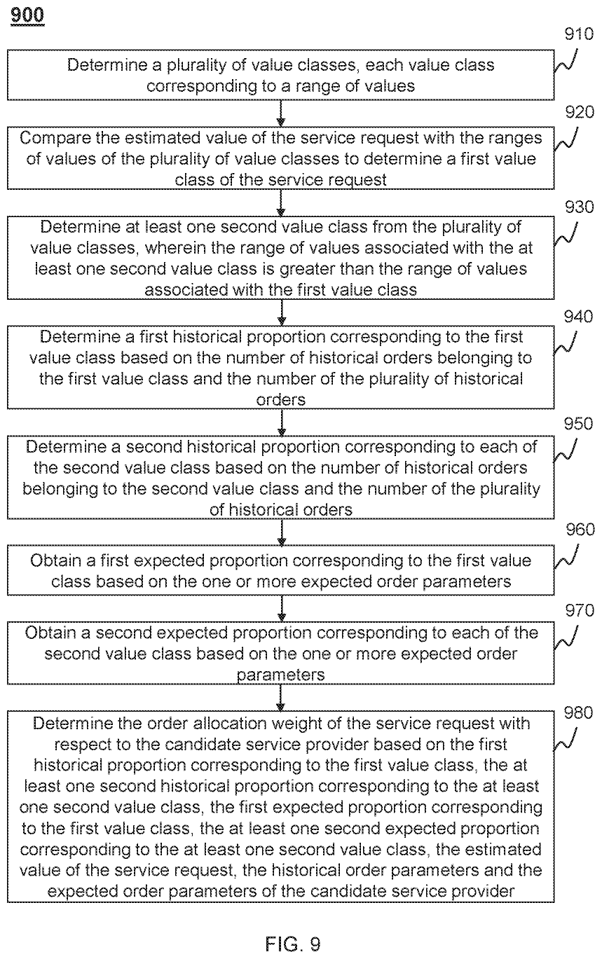

In 760, the processing engine 112 (e.g., the first order allocation weight determination module 440) may determine that the service provider has the second grade. The processing engine 112 may also determine the order allocation weight of the service provider according to process 900 described in the present disclosure in connection FIG. 9.

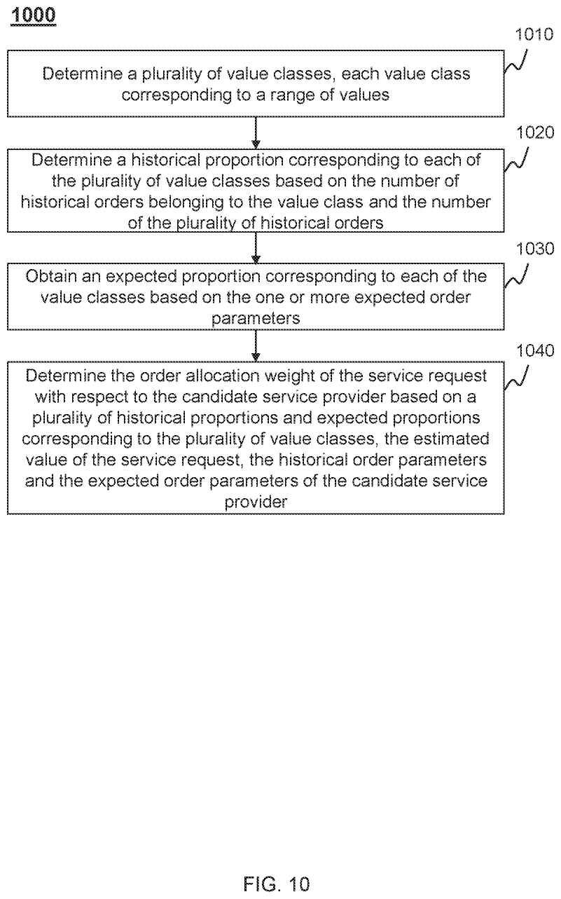

In 770, the processing engine 112 (e.g., the first order allocation weight determination module 440) may determine that the service provider has the third grade. The processing engine 112 may also determine the order allocation weight of the service provider according to process 1000 described in the present disclosure in connection FIG. 10.

In some embodiments, the order allocation weight for the similar service provider is the largest when determined as third grade, the medium when determined as having a second grade, and the smallest when determined as having a first grade. In some embodiments, if the income deviation of a service provider is negative or zero, the service provider is also determined as having the first grade. Alternatively, if the income deviation of a service provider is negative or zero, the service provider may be determined as having a fourth grade (not shown in the figure), the order allocation weight of the service provider at the fourth grade may be less than the order allocation weight of similar service provide at the first grade, second grade, or third grade.

It should be noted that the above descriptions of process 700 are provided for the purposes of illustration, and not intended to limit the scope of the present disclosure. For a person having ordinary skill in the art, various modifications and changes in the forms and details of the application of the above method and system may occur without departing from the principles in the present disclosure. However, those variations and modifications also fall within the scope of the present disclosure. For example, the one or more income thresholds may be added or omitted, and the number of grades of service providers associated with the one or more income thresholds may be increased or decreased accordingly. As another example, the values of the one or more income threshold may be adjusted.

FIG. 8 is a flowchart illustrating an exemplary process for determining an order allocation weight associated with a service provider with a first grade according to some embodiments of the present disclosure. In some embodiments, process 800 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 800. The operations of the illustrated process present below are intended to be illustrative. In some embodiments, process 800 may be accomplished with one or more additional operations not described and/or without one or more of the operations herein discussed. Additionally, the order in which the operations of the process as illustrated in FIG. 8 and described below is not intended to be limiting.

When the service provider (e.g., the candidate service provider) is determined as having the first grade, the income deviation of the service provider may be less than the first income threshold, which may indicate that the actual income is slightly less than the expected income. The processing engine 112 (e.g., the first order allocation weight determination module 440) may only consider the estimated value of the service request, the historical order parameters and expected order parameters associated with the value class that the service request belongs to in order to determine the order allocation weight of the service provider.

In 810, the processing engine 112 (e.g., the first order allocation weight determination module 440) may determine a plurality of value classes. Each value class may correspond to a range of values (or referred to as a value range). For example, the plurality of value classes may include three value classes, namely, value classes A, B, and C. The three value classes may correspond to three ranges of values (e.g., a range of values (a1, a2), a range of values (b1, b2), a range of values (c1, c2), respectively). The three ranges of values may or may not overlap with each other. For example, the range of values may be sequenced according to their values as: a2>a1>b2>b1>c2>c1. It should be noted that the above description of the value classes is merely provided for illustration purposes, one or more value classes may be added or omitted.

In 820, the processing engine 112 (e.g., the first order allocation weight determination module 440) may compare the estimated value of the service request with the ranges of values of the plurality of value classes to determine a first value class of the service request. For example, if the estimated value of the service request belongs to (a1, a2) of value class A, the first value class of the service request may be determined as having the value class A.

In 830, the processing engine 112 (e.g., the first order allocation weight determination module 440) may determine a first historical proportion corresponding to the first value class based on the number count of historical orders belonging to the first value class and the number count of the plurality of historical orders. In some embodiments, the processing engine 112 (e.g., the first order allocation weight determination module 440) may determine the first historical proportion corresponding to the first value class by dividing the number of historical orders belonging to the first value class by the number of the plurality of historical orders.

In 840, the processing engine 112 (e.g., the first order allocation weight determination module 440) may obtain a first expected proportion corresponding to the first value class based on the one or more expected order parameters. In some embodiments, the one or more expected order parameters may be set automatically by the online-to-offline service system 100 or manually by the service provider, and the first expected proportion may be extracted from the one or more expected order parameters.

In 850, the processing engine 112 (e.g., the first order allocation weight determination module 440) may determine the order allocation weight of the service request with respect to the service provider based on the first historical proportion corresponding to the first value class, the first expected proportion corresponding to the first value class, the estimated value of the service request, the historical order parameters and/or the expected order parameters of the service provider. In some embodiments, the processing engine 112 (e.g., the first order allocation weight determination module 440) may determine the order allocation weight of the order with respect to the service provider based on a predetermined first weight determination algorithm. The first weight determination algorithm may be expressed as follows:

$${e}^{- {( \frac{P \times T \times R - S \times r - V}{P \times T \times R - S \times r} )}^{2}} , \qquad ( 3 )$$

where P denotes an expected income at the unit time of a service provider, T denotes a historical online time length of the service provider, S denotes the total value of all historical orders of the service provider, V denotes an estimated value of the service request, r denotes a historical proportion corresponding to a value classes that the service request belongs to, and R denotes an expected proportion corresponding to the value classes that the service request belongs to.

FIG. 9 is a flowchart illustrating an exemplary process for determining an order allocation weight associated with a service provider (e.g., a candidate service provider) with a second grade according to some embodiments of the present disclosure. In some embodiments, process 900 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 900. The operations of the illustrated process present below are intended to be illustrative. In some embodiments, process 900 may be accomplished with one or more additional operations not described and/or without one or more of the operations herein discussed. Additionally, the order in which the operations of the process as illustrated in FIG. 9 and described below is not intended to be limiting.

When the service provider (e.g., the candidate service provider) is determined as having the second grade, the income deviation of the service provider may be greater than or equal to the first income threshold and less than the second income threshold, which may indicate that the difference between historical income and the expected income is at a medium level. The processing engine 112 (e.g., the first order allocation weight determination module 440) may consider the estimated value of the service request, the historical order parameters and expected order parameters associated with the first value class that the service request belongs to and the second value classes higher than the first value class in order to determine the order allocation weight of the service provider.

In 910, the processing engine 112 (e.g., the first order allocation weight determination module 440) may determine a plurality of value classes. Each value class may correspond to a range of values (or referred to as a value range). For example, the plurality of value classes may include three value classes, namely, value classes A, B, and C. The three value classes may correspond to three ranges of values (e.g., a range of values (a1, a2), a range of values (b1, b2), a range of values (c1, c2), respectively). The three ranges of values may or may not overlap with each other. For example, the range of values may be sequenced according to their values as: a2>a1>b2>b1>c2>c1. It should be noted that the above descriptions of the value classes are merely provided for illustration purposes, one or more value classes may be added or omitted.

In 920, the processing engine 112 (e.g., the first order allocation weight determination module 440) may compare the estimated value of the service request with the ranges of values of the plurality of value classes to determine a first value class of the service request. For example, if the estimated value of the service request belongs to (c1, c2) of value class C, the first value class of the service request may be determined as belonging to value class C.

In 930, the processing engine 112 (e.g., the first order allocation weight determination module 440) may determine at least one second value class from the plurality of value classes, wherein the range of values associated with the at least one second value class is greater than the range of values associated with the first value class. For example, if the estimated value of the service request belongs to value class C, the at least one second value class may be determined as the value class A and/or B having a value range higher than that of C.

In 940, the processing engine 112 (e.g., the first order allocation weight determination module 440) may determine a first historical proportion corresponding to the first value class based on the number of historical orders belonging to the first value class and the number of the plurality of historical orders. In some embodiments, the processing engine 112 (e.g., the first order allocation weight determination module 440) may determine the first historical proportion corresponding to the first value class by dividing the number count of historical orders belonging to the first value class by the number count of the plurality of historical orders. For example, the processing engine 112 (e.g., the first order allocation weight determination module 440) may determine the first historical proportion corresponding to the value class C by dividing the number count of historical orders belonging to the value class C by the number count of the plurality of historical orders.

In 950, the processing engine 112 (e.g., the first order allocation weight determination module 440) may determine a second historical proportion corresponding to each of the at least one second value class based on the number count of historical orders belonging to the second value class and the number count of the plurality of historical orders. In some embodiments, the processing engine 112 (e.g., the first order allocation weight determination module 440) may determine the second historical proportion corresponding to each of the at least one second value class (e.g., value class A, value class B) by dividing the number count of historical orders belonging to the second value class by the number count of the plurality of historical orders.

In 960, the processing engine 112 (e.g., the first order allocation weight determination module 440) may obtain a first expected proportion corresponding to the first value class based on the one or more expected order parameters. In some embodiments, the first expected proportion corresponding to the first value class may be set automatically by the online-to-offline service system 100 or manually by the service provider. If the estimated value of the service request belongs to value class C, the first expected proportion corresponding to the value class C may be obtained.

In 970, the processing engine 112 (e.g., the first order allocation weight determination module 440) may obtain a second expected proportion corresponding to each of the at least one second value class based on the one or more expected order parameters. In some embodiments, the second expected proportion corresponding to each of the at least one second value class may be set automatically by the online-to-offline service system 100 or manually by the service provider. For example, the second expected proportion corresponding to the value class A and/or the value class B may be obtained.

In 980, the processing engine 112 (e.g., the first order allocation weight determination module 440) may determine the order allocation weight of the service request with respect to the service provider based on the first historical proportion corresponding to the first value class, the at least one second historical proportion corresponding to the at least one second value class, the first expected proportion corresponding to the first value class, the at least one second expected proportion corresponding to the at least one second value class, the estimated value of the service request, the historical order parameters and/or the expected order parameters of the service provider. In some embodiments, the processing engine 112 (e.g., the first order allocation weight determination module 440) may determine the order allocation weight of the service request with respect to the service provider using a second weight determination algorithm. The second weight determination algorithm may be expressed as follows:

$$max ( {e}^{- {( \frac{P \times T - S - V}{P \times T - S} )}^{2}} , {e}^{- {( \frac{P \times T \times R - S \times r - V}{P \times T \times R - S \times r} )}^{2}} , {e}^{- {( \frac{P \times T \times {R}^{′} - S \times {r}^{′} - V}{P \times T \times {R}^{′} - S \times {r}^{′}} )}^{2}} ) , \qquad ( 4 )$$

where P denotes an expected income at the unit time of a service provider, T denotes a historical online time length of the service provider, S denotes the total value of all historical orders of the service provider, V denotes an estimated value of the service request, r denotes a historical proportion corresponding to a value classes that the service request belongs to, r′ denotes a historical proportion corresponding to a value classes that is higher than the value class that the service request belongs to, R denotes an expected proportion corresponding to the value classes that the service request belongs to, and R′ denotes an expected proportion corresponding to the value class that is higher than the value class that the service request belongs to.

FIG. 10 is a flowchart illustrating an exemplary process for determining an order allocation weight associated with a service provider with a third grade according to some embodiments of the present disclosure. In some embodiments, process 1000 may be implemented as a set of instructions (e.g., an application) stored in the storage 150, storage 260, or storage 390. The CPU 210, the CPU 340, the processing engine 112 and/or the modules in FIG. 4 may execute the set of instructions, and when executing the instructions, the CPU 210, the CPU 340, the processing engine 112 and/or the modules in FIG. 4 may be configured to perform process 1000. The operations of the illustrated process present below are intended to be illustrative. In some embodiments, process 1000 may be accomplished with one or more additional operations not described and/or without one or more of the operations herein discussed. Additionally, the order in which the operations of the process as illustrated in FIG. 10 and described below is not intended to be limiting.

When the service provider (e.g., the candidate service provider) is determined as having the third grade, the income deviation of the service provider may be greater than the second income threshold, which may indicate that a difference between the actual income comparing and the expected income is very large. The processing engine 112 (e.g., the first order allocation weight determination module 440) may consider all the value classes, and the order allocation weights calculated based on them, and select the highest order allocation weight from the order allocation weights regardless of which value class the service request belongs to.

In 1010, the processing engine 112 (e.g., the first order allocation weight determination module 440) may determine a plurality of value classes. Each value class may correspond to a range of values. For example, the plurality of value classes may include three value classes, namely, value classes A, B, and C. The three value classes may correspond to three ranges of values (e.g., a range of values (a1, a2), a range of values (b1, b2), a range of values (c1, c2), respectively). The three ranges of values may or may not overlap with each other. For example, the range of values may be sequenced according to their values as: a2>a1>b2>b1>c2>c1. It should be noted that the above description of the value classes is merely provided for illustration purposes, one or more value classes may be added or omitted.

In 1020, the processing engine 112 (e.g., the first order allocation weight determination module 440) may determine a historical proportion corresponding to each of the plurality of value classes based on the number count of historical orders belonging to the value class and the number count of the plurality of historical orders. In some embodiments, the processing engine 112 (e.g., the first order allocation weight determination module 440) may determine the historical proportion corresponding to each of the plurality of value classes by dividing the number count of historical orders belonging to the value class by the number count of the plurality of historical orders.

In 1030, the processing engine 112 (e.g., the first order allocation weight determination module 440) may obtain an expected proportion corresponding to each of the value classes based on the one or more expected order parameters. In some embodiments, the expected proportion corresponding to each of the value classes may be set automatically by the online-to-offline service system 100 or manually by the service provider.

In 1040, the processing engine 112 (e.g., the first order allocation weight determination module 440) may determine the order allocation weight of the service request with respect to the service provider based on a plurality of historical proportions and expected proportions corresponding to the plurality of value classes, the estimated value of the service request, the historical order parameters and/or the expected order parameters of the service provider. In some embodiments, the processing engine 112 (e.g., the first order allocation weight determination module 440) may determine the order allocation weight of the service request with respect to the service provider using a third weight determination algorithm. The third weight determination algorithm may be expressed as follows:

$$max ( {e}^{- {( \frac{P \times T - S - V}{P \times T - S} )}^{2}} , {e}^{- {( \frac{P \times T \times {R}_{1} - S \times {r}_{1} - V}{P \times T \times {R}_{1} - S \times {r}_{1}} )}^{2}} , … , {e}^{- {( \frac{P \times T \times {R}_{n} - S \times {r}_{n} - V}{P \times T \times {R}_{n} - S \times {r}_{n}} )}^{2}} ) , \qquad ( 5 )$$

where P denotes an expected income at the unit time of a service provider, T denotes a historical online time length of the service provider, S denotes the total value of all historical orders of the service provider, V denotes an estimated value of the service request, {r₁, . . . , rₙ} denotes historical proportions corresponding to each of n value classes, and {R₁, . . . , Rₙ}, denotes expected proportions corresponding to each of the n value classes.

FIG. 11 is an exemplary unmatched bipartite graph associated with service requests and service providers. As shown in the FIG. 11, three service requests 1111, 1112, and 1113 are to be allocated to three candidate service providers 1121, 1122, and 1123. The processing engine 112 (e.g., the first order allocation weight determination module 440, the second order allocation weight determination module 460) may determine a plurality of order allocation weights of the service providers with respect to these service requests (shown as straight lines connecting the service providers and service requests). For example, the order allocation weight 1131 of the service provider 1121 with respect to the service request 1111 may be 3, and the order allocation weight 1132 of service provider 1121 with respect to the service request 1112 may be 2. In some embodiments, the processing engine 112 may search for a match (e.g., a complete match) of the bipartite graph based on, e.g., a Hungarian algorithm, Hopcroft-Karp algorithm, or a Kuhn-Munkres algorithm. Specifically, in the Hungarian algorithm, values of one or more vertices, usually on the left, in the bipartite graph are initialized. A match of the bipartite graph is searched for using a Hungary algorithm. If the match of the bipartite graph is not found, the values of the one or more vertices may be modified, and the match of the bipartite graph may be searched for using the Hungarian algorithm (or a different algorithm) until the match of the bipartite graph is found. The service request of the service requester may be allocated to one of the candidate service providers based on the match of the bipartite graph. The match may meet at least one of the following conditions: each service request corresponds to only one service provider; each service provider corresponds to only one service request; as many as possible service requests find a matched service provider; and the sum of order allocation weight corresponding to matched service requests and service providers is as high as possible.

FIG. 12 is an exemplary matched bipartite graph associated with service requests and service providers. As shown in the FIG. 12, a match (e.g., a complete match) of the bipartite graph is found. For example, each of the service requests 1111, 1112 and 1113 is allocated to a service provider (e.g., service provider 1121, 1122, or 1123), all the service requests find a matched a service provider, all the service provider find a matched service request and the sum of order allocation weight corresponding to the matched service requests and service providers are the greatest among all possible match of the bipartite graph.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system, comprising:
a storage device including a set of instructions for allocating a service request to a service provider;
at least one processor in communication with the storage device, wherein when executing the set of instructions, the at least one processor is configured to cause the system to:
receive a first service request;
determine an estimated value of the first service request;
determine at least one candidate service provider for the first service request;
for each of the at least one candidate service provider,
obtain one or more historical order parameters of the candidate service provider;
receive one or more expected order parameters of the candidate service provider; and
determine an order allocation weight of the first service request with respect to the candidate service provider based on the estimated value of the first service request, the one or more historical order parameters, and the one or more expected order parameters of the service provider; and
determine a target service provider of the first service request from the at least one candidate service provider based on at least one order allocation weight of the first service request with respect to the at least one candidate service provider.

2. The system of claim 1, wherein
the one or more historical order parameters of the candidate service provider include a historical online time length of the candidate service provider and total values of historical orders of the candidate service provider; and
the one or more expected order parameters include an expected income at unit time.

3. The system of claim 2, wherein to determine the order allocation weight of the first service request with respect to the candidate service provider, the at least one processor is configured to cause the system to:
determine an expected income of the candidate service provider based on the historical online time length of the candidate service provider and the expected income at unit time; and
determine the order allocation weight of the first service request with respect the candidate service provider based on the expected income, the total values of historical orders, and the estimated value of the first service request.

4. The system of claim 2, wherein to determine the order allocation weight of the first service request with respect to the candidate service provider, the at least one processor is further configured to cause the system to:
determine an income deviation of the candidate service provider based on the historical online time length of the candidate service provider, the expected income at unit time, and the total values of historical orders of the candidate service provider;
compare the income deviation of the candidate service provider with at least one income threshold;
determine a grade of the candidate service provider based on a result of the comparison between the income deviation and the at least one income threshold; and
determine the order allocation weight of the first service request with respect to the candidate service provider based on the grade of the candidate service provider, the estimated value of the first service request, the historical order parameters, and the expected order parameters of the candidate service provider.

5. The system of claim 4, wherein
the at least one income threshold includes a first threshold and a second threshold, the second threshold being greater than or equal to the first threshold; and
to determine the grade of the candidate service provider based on a result of the comparison between the income deviation and the income threshold, the at least one processor is configured to cause the system to:
determine the grade of the candidate service provider as a first grade based on a result of the comparison that the income deviation of the candidate service provider is less than the first threshold;
determine the grade of the candidate service provider as a second grade based on a result of the comparison that the income deviation of the candidate service provider is greater than or equal to the first threshold and less than the second threshold; and
determine the grade of the candidate service provider as a third grade based on a result of the comparison that the income deviation of the candidate service provider is greater than or equal to the second threshold.

6. The system of claim 5, wherein
the grade of the candidate service provider is determined as the first grade; and
to determine the order allocation weight of the first service request with respect to the candidate service provider, the at least one processor is configured to cause the system to:
determine a plurality of value classes, each of the plurality of value class corresponding to a range of values;
compare the estimated value of the first service request with the ranges of values of the plurality of value classes to determine a first value class of the first service request;
determine a first historical proportion corresponding to the first value class based on a number count of historical orders belonging to the first value class and the number count of the historical orders of the candidate service provider;
obtain a first expected proportion corresponding to the first value class based on the one or more expected order parameters; and
determine the order allocation weight of the first service request with respect to the candidate service provider based on the first historical proportion corresponding to the first value class, the first expected proportion corresponding to the first value class, the estimated value of the first service request, the historical order parameters, and the expected order parameters of the candidate service provider.

7. The system of claim 5, wherein the grade of the candidate service provider is second grade, and to determine the order allocation weight of the first service request with respect to the candidate service provider, the at least one processor is configured to cause the system to:
determine a plurality of value classes, each of the plurality of value class corresponding to a range of values;
compare the estimated value of the first service request with the ranges of values of the plurality of value classes to determine a first value class of the first service request;
determine at least one second value class from the plurality of value classes, wherein the range of values associated with the at least one second value class is greater than the range of values associated with the first value class;
determine a first historical proportion corresponding to the first value class based on the number count of historical orders belonging to the first value class and the number count of the historical orders of the candidate service provider;
obtain a first expected proportion corresponding to the first value class based on the one or more expected order parameters;
for each of the at least one second value class,
determine a second historical proportion corresponding to the second value class based on the number count of historical orders belonging to the second value class and the number count of the plurality of historical orders; and
obtain a second expected proportion corresponding to the second value class based on the one or more expected order parameters; and
determine the order allocation weight of the first service request with respect to the candidate service provider based on the first historical proportion corresponding to the first value class, the second historical proportions corresponding to the at least one second value class, the first expected proportion corresponding to the first value class, the second expected proportions corresponding to the at least one second value class, the estimated value of the first service request, the historical order parameters and the expected order parameters of the candidate service provider.

8. The system of claim 5, wherein the grade of the each of the at least one candidate service provider is the third grade, and to determine the order allocation weight of the first service request with respect to the candidate service provider, the at least one processor is configured to cause the system to:
determine a plurality of value classes, each value class corresponding to a range of values;
for each of the plurality of value classes,
determine a historical proportion corresponding to the value class based on the number count of historical orders belonging to the value class and the number count of the historical orders of the candidate service provider; and
obtain an expected proportion corresponding to the value class based on the one or more expected order parameters; and
determine the order allocation weight of the first service request with respect to the candidate service provider based on a plurality of historical proportions and expected proportions corresponding to the plurality of value classes, the estimated value of the first service request, the historical order parameters and the expected order parameters of the candidate service provider.

9. The system of claim 1, wherein to determine the target service provider of the first service request from the at least one candidate service provider based on the at least one order allocation weight of the first service request with respect to the at least one candidate service provider, the at least one processor is configured to cause the system to:
for each of the at least one second user device,
receive a second service request;
determine at least one order allocation weight of the second service request with respect to the at least one candidate service provider;
construct a bipartite graph relating the first service request and the at least one second service request to the at least one candidate service provider;
execute a bipartite graph matching algorithm on the bipartite graph to generate a matched bipartite graph based on the at least one order allocation weight of the first service request and each of the at least one second service request with respect to the at least one candidate service provider; and
determine the target service provider of the first service request from the at least one candidate service provider based on the matched bipartite graph.

10. The system of claim 9, wherein the bipartite graph matching algorithm is at least one of Hungarian algorithm, Hopcroft-Karp algorithm, or Kuhn-Munkres algorithm.

11. A method implemented on a computing device having at least one storage device storing a set of instructions for allocating a service request to a service provider, and at least one processor in communication with the at least one storage device, the method comprising:
receiving a first service request;
determining an estimated value of the first service request;
determining at least one candidate service provider for the first service request;
for each of the at least one candidate service provider,
obtaining one or more historical order parameters of the candidate service provider;
receiving one or more expected order parameters of the candidate service provider; and
determining an order allocation weight of the first service request with respect to the candidate service provider based on the estimated value of the first service request, the one or more historical order parameters, and the one or more expected order parameters of the service provider; and
determining a target service provider of the first service request from the at least one candidate service provider based on at least one order allocation weight of the first service request with respect to the at least one candidate service provider.

12. The method of claim 11, wherein
the one or more historical order parameters of the candidate service provider include a historical online time length of the candidate service provider and total values of historical orders of the candidate service provider; and
the one or more expected order parameters include an expected income at unit time.

13. The method of claim 12, wherein the determining the order allocation weight of the first service request with respect to the candidate service provider comprises:
determining an expected income of the candidate service provider based on the historical online time length of the candidate service provider and the expected income at unit time; and
determining the order allocation weight of the first service request with respect the candidate service provider based on the expected income, the total values of historical orders, and the estimated value of the first service request.

14. The method of claim 12, wherein the determining the order allocation weight of the first service request with respect to the candidate service provider comprises:
determining an income deviation of the candidate service provider based on the historical online time length of the candidate service provider, the expected income at unit time, and the total values of historical orders of the candidate service provider,
comparing the income deviation of the candidate service provider with at least one income threshold;
determining a grade of the candidate service provider based on a result of the comparison between the income deviation and the at least one income threshold; and
determining the order allocation weight of the first service request with respect to the candidate service provider based on the grade of the candidate service provider, the estimated value of the first service request, the historical order parameters, and the expected order parameters of the candidate service provider.

15. The method of claim 14, wherein
the at least one income threshold includes a first threshold and a second threshold, the second threshold being greater than or equal to the first threshold; and
the determining the grade of the candidate service provider based on a result of the comparison between the income deviation and the income threshold comprises:
determining the grade of the candidate service provider as a first grade based on a result of the comparison that the income deviation of the candidate service provider is less than the first threshold;
determining the grade of the candidate service provider as a second grade based on a result of the comparison that the income deviation of the candidate service provider is greater than or equal to the first threshold and less than the second threshold; and
determining the grade of the candidate service provider as a third grade based on a result of the comparison that the income deviation of the candidate service provider is greater than or equal to the second threshold.

16. The method of claim 15, wherein
the grade of the candidate service provider is the first grade; and
the determining the order allocation weight of the first service request with respect to the candidate service provider comprises:
determining a plurality of value classes, each of the plurality of value class corresponding to a range of values;
comparing the estimated value of the first service request with the ranges of values of the plurality of value classes to determine a first value class of the first service request;
determining a first historical proportion corresponding to the first value class based on a number count of historical orders belonging to the first value class and the number count of the historical orders of the candidate service provider;
obtaining a first expected proportion corresponding to the first value class based on the one or more expected order parameters; and
determining the order allocation weight of the first service request with respect to the candidate service provider based on the first historical proportion corresponding to the first value class, the first expected proportion corresponding to the first value class, the estimated value of the first service request, the historical order parameters, and the expected order parameters of the candidate service provider.

17. The method of claim 15, wherein the grade of the candidate service provider is the second grade, and the determining the order allocation weight of the first service request with respect to the candidate service provider comprises:
determining a plurality of value classes, each of the plurality of value class corresponding to a range of values;
comparing the estimated value of the first service request with the ranges of values of the plurality of value classes to determine a first value class of the first service request;
determining at least one second value class from the plurality of value classes, wherein the range of values associated with the at least one second value class is greater than the range of values associated with the first value class;
determining a first historical proportion corresponding to the first value class based on the number count of historical orders belonging to the first value class and the number count of the historical orders of the candidate service provider;
obtaining a first expected proportion corresponding to the first value class based on the one or more expected order parameters;
for each of the at least one second value class,
determining a second historical proportion corresponding to the second value class based on the number count of historical orders belonging to the second value class and the number count of the plurality of historical orders; and
obtaining a second expected proportion corresponding to the second value class based on the one or more expected order parameters; and
determining the order allocation weight of the first service request with respect to the candidate service provider based on the first historical proportion corresponding to the first value class, the second historical proportions corresponding to the at least one second value class, the first expected proportion corresponding to the first value class, the second expected proportions corresponding to the at least one second value class, the estimated value of the first service request, the historical order parameters and the expected order parameters of the candidate service provider.

18. The method of claim 15, wherein the grade of the each of the at least one candidate service provider is the third grade, and the determining the order allocation weight of the first service request with respect to the candidate service provider comprises:
determining a plurality of value classes, each value class corresponding to a range of values;
for each of the plurality of value classes,
determining a historical proportion corresponding to the value class based on the number count of historical orders belonging to the value class and the number count of the historical orders of the candidate service provider; and
obtaining an expected proportion corresponding to the value class based on the one or more expected order parameters; and
determining the order allocation weight of the first service request with respect to the candidate service provider based on a plurality of historical proportions and expected proportions corresponding to the plurality of value classes, the estimated value of the first service request, the historical order parameters and the expected order parameters of the candidate service provider.

19. The method of claim 11, wherein the determining the target service provider of the first service request from the at least one candidate service provider based on the at least one order allocation weight of the first service request with respect to the at least one candidate service provider comprises:
for each of the at least one second user device,
receiving a second service request;
determining at least one order allocation weight of the second service request with respect to the at least one candidate service provider;
constructing a bipartite graph relating the first service request and the at least one second service request to the at least one candidate service provider;
executing a bipartite graph matching algorithm on the bipartite graph to generate a matched bipartite graph based on the at least one order allocation weight of the first service request and each of the at least one second service request with respect to the at least one candidate service provider; and
determining the target service provider of the first service request from the at least one candidate service provider based on the matched bipartite graph.

20. A non-transitory computer readable medium, comprising at least one set of instructions for allocating a service request to a service provider, wherein when executed by at least one processor of an electronic terminal, the at least one set of instructions directs the at least one processor to perform acts of:
receiving a first service request;
determining an estimated value of the first service request;
determining at least one candidate service provider for the first service request;
for each of the at least one candidate service provider,
obtaining one or more historical order parameters of the candidate service provider;
receiving one or more expected order parameters of the candidate service provider; and
determining an order allocation weight of the first service request with respect to the candidate service provider based on the estimated value of the first service request, the one or more historical order parameters, and the one or more expected order parameters of the service provider; and
determining a target service provider of the first service request from the at least one candidate service provider based on at least one order allocation weight of the first service request with respect to the at least one candidate service provider.

21-47. (canceled)
